(19) United States
(12) Patent Application Publication
(10) Pub. No.: US 2012/0290373 A1
(43) Pub. Date: Nov. 15, 2012

(54) APPARATUS AND METHOD FOR MARKETING-BASED DYNAMIC ATTRIBUTION

(75) Inventors: MICHAEL E. FERZACCA, Potomac, MD (US); Christopher M. MacAulay, Arlington, VA (US); Gary J. Smith, Woodbine, MD (US)

(73) Assignee: IGNITE MEDIA SOLUTIONS, LLC, McLean, VA (US)

(21) Appl. No.: 13/105,892

(22) Filed: May 12, 2011

(51) Int. Cl. G06Q 30/00

(52) U.S. Cl. 705/14.7

(57) ABSTRACT

A computer implemented method and apparatus for determining marketing-based attribution that may be used for targeted and effective acquisition of customers when multiple marketing interactions are employed to target the consumers attention. The method and apparatus provide also provides a mechanism for appropriately rewarding the marketing partners in customer acquisition.

### CROSS-REFERENCE TO RELATED APPLICATIONS

The present invention and application relates to, and claims the benefit of the earlier filing date and priority of U.S. Provisional Patent Application 61/333,588 filed May 11, 2010, which is hereby incorporated by reference in its entirety.

### FIELD OF THE INVENTION

The present invention relates generally to a system and method for dynamic attribution of revenue and effectiveness of marketing activities that contributed to the consummation of a transaction relating to products, services, and marketing leads.

### BACKGROUND OF THE INVENTION

Traditionally, determining the value and effectively attributing credit for marketing interaction (marketing campaign for a specific customer acquisition) was quite simple. For example, the perceived value of a direct response television commercial was determined by evaluating each television commercial based solely on the revenue generated by the responses (telephone calls and store visits) to the television commercial divided by the cost of the television commercial. As the purchase by consumers evolved from simple inbound telephone calls and store visits to the various on-line and off-line access points from where a consumer can place its orders, the need to attribute the value of the revenue generated by the response to a marketing interaction has become more complex.

The marketing interaction of potential customers with a television commercial or print media now may encompass various forms of on-line and off-line marketing interactions. On-line marketing interactions may include one, or more of, an online banner advertisement, online search marketing, organic search engine optimization, pay per-click search, paid search engine marketing, e-mail marketing, website optimization, and website redirection, etc. Off-line marketing could involve the use of telephone, print media, television commercial, radio commercial, postal media, newspaper, television marketing, and billboards, etc. In addition, advertising over the Internet has evolved such that correlating the marketing interaction to the response generated by it has become increasingly difficult. For example, effectively and accurately rewarding marketing partners has become more challenging when using affiliate marketing—using one website to drive traffic to another website or product.

As marketing dollars are spent for a broad variety of marketing interactions, one common problem encountered by the marketers is their inability to proportionately reward marketing partners for their contribution for customer acquisition. Another problem commonly encountered is the inability of marketers to choose the most effective marketing interaction to market their particular products, services, or websites. This is because marketers do not have a real-time or near real-time marketing data information, both online and offline, which begins with the customer's first marketing interaction and continues all the way through customer acquisition. The present invention addresses these and other problems.

### SUMMARY OF THE INVENTION

Responsive to the foregoing challenges, Applicants have developed a method for

Applicants have also developed a method for marketing-based attribution that may be used for the acquisition of customers

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements. The drawings are exemplary only, and should not be construed as limiting the invention.

FIG. 1 is an exemplary diagram of the interaction between the participants of the correlation and attribution system that operates in accordance with an embodiment of the present invention.

FIG. 2 is a schematic diagram of a portion of the correlation and attribution system, which indicates information flow between elements of the system in accordance with an embodiment of the present invention.

FIG. 3 is an exemplary schematic diagram of a portion of the data that is populated into the attribution data warehouse shown in FIG. 2.

FIG. 4 is a flow chart that illustrates the steps of a computer-implemented method of updating the reward status of the marketing interaction, which is carried out by the attribution data warehouse in accordance with an embodiment of the present invention.

### DETAILED DESCRIPTION OF EMBODIMENTS OF THE INVENTION

Reference will now be made in detail to system and method embodiments of the present invention, examples of which are illustrated in the accompanying drawings. The system and method of the present invention relates to creation of a tangible result for marketing-based attribution that may be used for the acquisition of customers for specific products, services, website traffic, promotions, and other marketing leads. The system and method of attribution of the present invention provides a tangible real-time data associated with each marketing interaction, both online and offline, and permits data regarding a specific customer acquisition to be associated with the marketing activities that contributed to the specific customer acquisition.

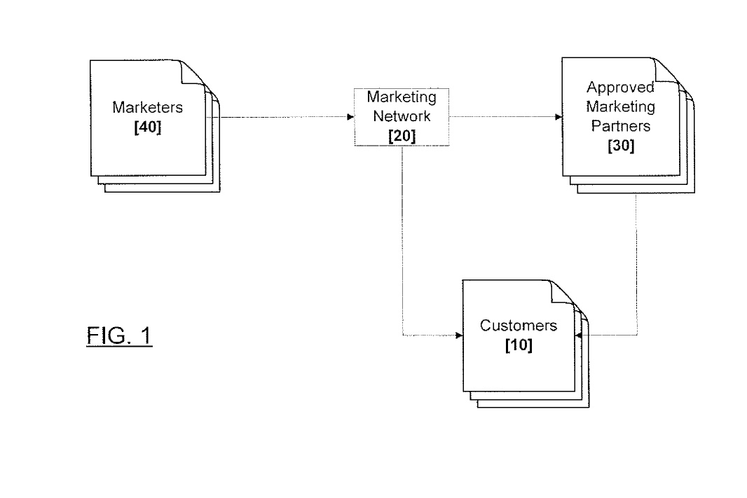

FIG. 1 illustrates the relationship of the participants of the attribution system that operates in accordance with an embodiment of the present invention. As shown in FIG. 1, the marketers 40 that want to sell, or increase awareness of, their goods and services may enter into agreements with the marketing network 20 for the sale and advertisement of their goods and services. The marketing network 20 may advertise and sell these goods and services directly to customers 10 and may also act as an intermediary between the marketer 40 that wants to sell and advertise the goods and services and the marketing network's approved marketing partners 30. The approved marketing partners 30 may utilize a variety of marketing interactions 60, which are described in detail below, to sell and advertise the goods and services of the marketer 40. The marketing network 20 may be rewarded or compensated by the marketers 40 based on commission that may be triggered by the placement of an advertisement or a sale of goods and services, an event that is also known as customer acquisition. The marketing network 20 may, in turn, allocate and distribute a portion of the commission to its approved marketing partners 30 who influenced the customer acquisition. The marketing network 20 may reward one or more approved marketing partners 30 for each customer acquisition brought about by the approved marketing partner's 30 marketing efforts.

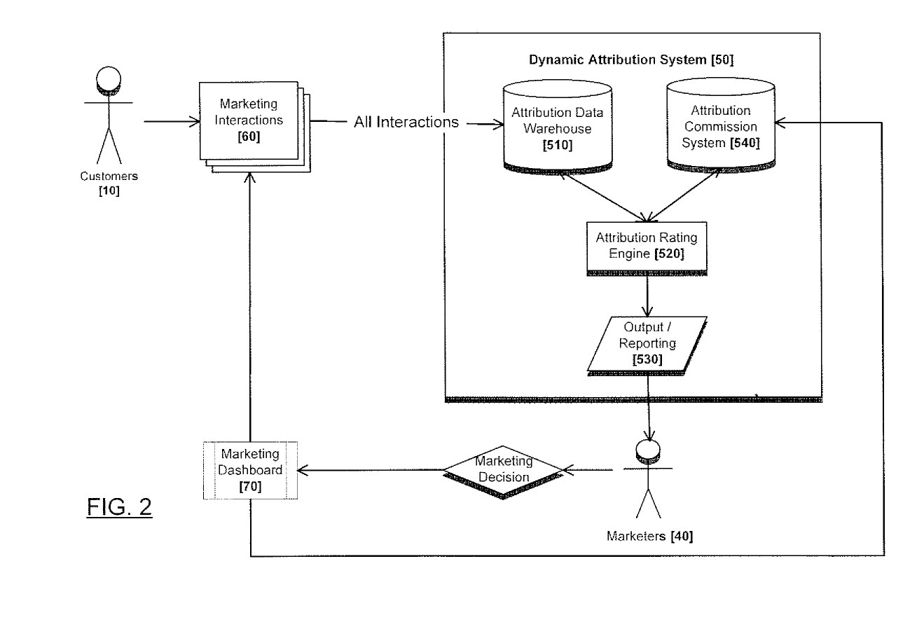

FIG. 2 illustrates the architecture of the attribution system that operates in accordance with an embodiment of the present invention. The dynamic attribution system 50 may include an attribution data warehouse 510, which may be used to collect all marketing interactions associated with marketing programs and the demographic information associated with each specific customer. The attribution data warehouse 510 may also collect and store the transaction data and the post-transaction data related to customer acquisition. The attribution data warehouse 510 may have a database comprising one or more computers (including processing and memory devices) that collectively provide a data storage and management device through hardware and/or software implementation.

As shown in FIG. 2, the attribution data warehouse 510 may be connected via wired or wireless connection to an attribution rating engine (also referred to as “ARE”) 520. The attribution rating engine 520 may be a reinforcement learning engine that utilizes the acquired marketing interactions 60 over discrete time steps to improve and optimize the marketing and reward system for customer acquisition. The attribution rating engine 520 may be a custom software application residing on a computer server containing one or more CPUs and data manipulation and storage devices. The attribution rating engine 520 may also be connected via wired or wireless connection to an attribution commission system 540. The attribution commission system 540 may store the reward or commission information associated with each marketing interaction 60 and specific customer acquisition over discrete time steps. The attribution data warehouse 510 and the attribution commission system 540 may have separate dedicated physical databases assigned to them. Alternatively, the attribution data warehouse 510 and the attribution commission system 540 may share the same physical database with logical and software based partitions. The database may be any type of data repository including, for example, an SQL table or ASCII text file.

As shown in FIG. 1, the dynamic attribution system 50 may include an output/reporting component 530. The output/reporting component 530 may provide marketing and commission related feedback to the marketer through physical reports or in electronic format through a network. The network preferably may be the Internet, but may be any wired or wireless connection means that permit the transmission of electronic information. The output/reporting component 530 may be a special use computer with permanent programming to accomplish the methods described herein, or a general use computer programmed with software to permit it to accomplish the methods described herein. Alternatively, the output/reporting component 530 may be implemented using any commercially available tool, like crystal reports or velocity reporting etc. The output/reporting component 530 may use these tools to create reports that are rendered in a visibly perceptible output. The output/reporting component 530 may receive information from the attribution data warehouse 510 and the attribution commission system 540 through the attribution rating engine 520. The output/reporting component 530 may be connected via wired or wireless connection to the attribution rating engine 520.

Based on the marketing and commission feedback that is rendered in a visibly perceptible output and received from the output/reporting component 530, the marketer or the company may decide to modify the available marketing interactions 60 and/or the reward/commission available for each customer acquisition. The marketer 40 may utilize the marketing dashboard 70 to modify the available marketing interaction and/or change the reward/commission available for each customer acquisition. The marketing dashboard 70 may be implemented using software on a general-purpose computer, such as a personal computer. The marketing dashboard 70 may interact with the user using one or more graphical user interfaces (“GUI”). The GUI may render the available marketing interactions 60 and the reward/commission available for each customer acquisition in a visible perceptible output to its user. The user of the marketing dashboard 70 may then use its visible perceptible output to modify the available marketing interaction and/or change the reward/commission available for each customer acquisition. The marketing dashboard 70 may connect with the dynamic attribution system 50 using either a wired or a wireless connection. Both wired and wireless computing devices for the marketing dashboard 70 are within the intended scope of the present invention.

The collective components of the dynamic attribution system 50 may be implemented as computer programs and associated database(s) that are run on, and provide storage for, general-purpose computers having memory and/or processing capabilities. Furthermore, these components may be used to collect, transform, and apply data in such a way as to produce a tangible result, including, but not limited to, the creation of: viewable display of information indicating the optimal ranking of various marketing interactions 60 that were selected for a particular marketing program; visually perceptible reporting of the optimal ranking of various marketing interactions that were selected for a particular marketing program; visually perceptible reporting of financial information related to the optimal ranking of various marketing interactions that were selected for a particular marketing program; visually perceptible reporting of the commission data stored for rewarding the marketing network and the approved marketing partner who influenced customer acquisition; and visually perceptible reporting of available marketing interactions 60 and the reward/commission available for each customer acquisition.

The dynamic attribution system 50 may collect all marketing interactions 60 associated with a marketing campaign and may report on what marketing interactions 60 lead to a customer acquisition. The dynamic attribution system 50 may serve as the collection point for all marketing interactions 60 associated to a specific customer 10, or demographic of a specific customer 10. The dynamic attribution system 50 may contain a set of Application Programming Interfaces (API), which allow various entities to submit data related to marketing interactions, customer acquisitions, customer quality and demographics, marketing campaign effectiveness, and commission and payments for all marketing interactions to the attribution data warehouse 510 and the attribution commission system 540. This information may be received by the dynamic attribution system 50 through a variety of standard electronic communication formats, such as FTP, SOAP, and standard web GET/POST, etc.

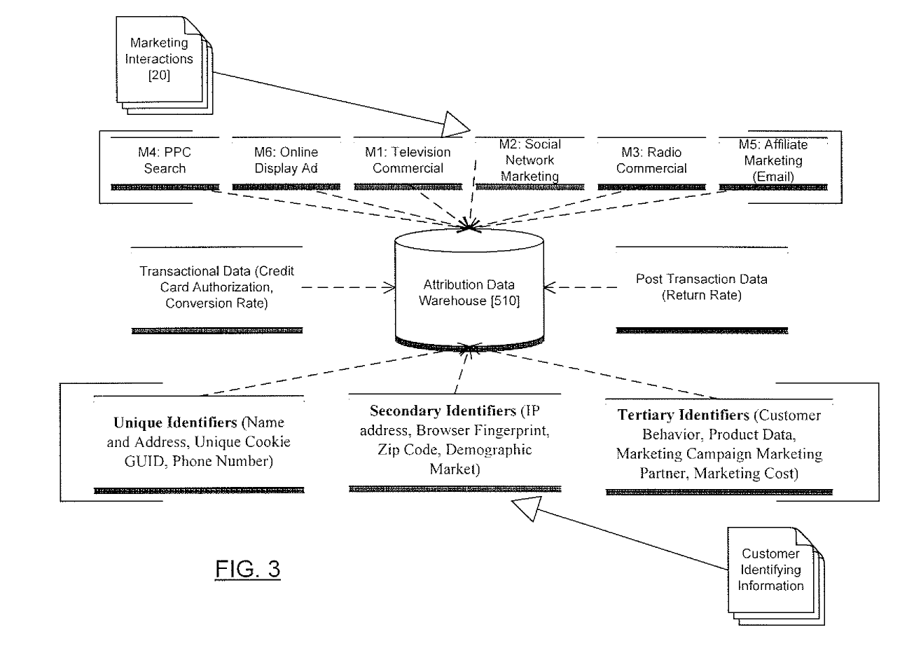

As shown in FIG. 3, the dynamic attribution system 50 may be provided with a set of data related to the marketing interactions 60 that a marketer 40 may use for a particular marketing campaign, which data may be stored in the attribution data warehouse 510. As shown in FIG. 2, the marketer 40 may provide this marketing interaction information to the dynamic attribution system 50 using the visually perceptible marketing dashboard 30. The marketing interactions 60 may include, but are not limited to, off-line interactions, i.e., television commercial (short and long form), radio commercial, print ad (newspaper, magazine, circular), billboards and offline display ads, etc. and on-line interactions, i.e., online display ad (view and click throughs), contextual ads, pay per click search, organic search, affiliate marketing, email marketing (in house lists and acquired lists), marketplace and auctions (eBay, Amazon), shopping feeds, co-registration marketing, social network marketing, etc. These marketing interactions 60 and their associated data types are described in detail in FIG. 5. The marketer 40 may also provide other information related to the marketing interactions 60 including, but not limited to, product data, and marketing campaign, marketing activity, marketing type, marketing channel, marketing partner, and marketing cost.

The dynamic attribution system 50 may identify marketing interactions 60 associated with a specific customer 10 through unique online sessions, cookie data, IP address, browser fingerprints, telephone number, physical address, or any other data that uniquely identifies a user. As shown in FIG. 3, the customer identification data comprising the unique identifiers, secondary identifier, and the tertiary identifiers may be stored in the attribution data warehouse 510. In addition, marketing interactions 60 may be associated broadly with a group of customers 10 with shared marketing interactions 60 through a shared demographic or other attribute, which is also called as secondary customer identifiers. For example, a TV ad spot shown in the New York City market could be associated to a customer acquisition from that same market. The data related to the TV ad spot shown in the New York City market and the resulting customer acquisition may be provided to the attribution data warehouse 510 by the marketers 40 using one or more of the APIs published by the dynamic attribution system 50. The demographic information for the associative marketing interactions 60 that may be stored include, but are not limited to, demographic market, designated market area (DMA), Television Market Area (FCC term), postal zip code, IP address, browser fingerprint, and demographic information such as age or gender.

The data stored in the attribution data warehouse 510 may also be used to build personally identifiable predictive customer information, which may include customer payment data, past buying behavior, return rates, and sites visited. This information may include, but is not limited to, date/time of customer acquisition, customer identifying information (including, but not limited to name, address, credit card, telephone number, IP address), product information, (including, but not limited to product id, product type, product source), acquisition type, (including, but not limited to order and lead), tracking tags, marketing source, product or service cost, taxes, shipping and handling charges, and source of acquisition (including, but not limited to web site, IVR, telephone operator, postal mail). If the last interaction in the customer acquisition process was performed by the marketing network 20, then this data may be provided by the in-house provisioning system to the attribution data warehouse 510 using one or more of the APIs published by the dynamic attribution system 50. If the last interaction in the customer acquisition process was performed by the approved marketing partner 30, then this data may be provided by the approved marketing partner's provisioning system to the attribution data warehouse 510 using one or more of the APIs published by the dynamic attribution system 50.

The in-house provisioning system and the approved marketing partners may also use the APIs to provide the attribution data warehouse 510 with information related to the Marketing Costs and Value. This information includes, but is not limited to advertising cost as a value of cost per impression (CPI), cost per mille or the advertisement cost per thousand views (CPM), cost per acquisition (CPA), cost per click (CPC) or other standard rates as defined in the industry. Each marketing activity, marketing channel, and marketing type may be assigned specific advertising costs, as well as a metric assigned to the real-time and historical performance of the associated marketing activity, marketing channel, or marketing type.

All the data collected by the APIs of the correlation and attribution system 50 may be stored within the attribution data warehouse 510. This data may be aggregated, de-duplicated and aligned by factors including, but not limited to, customer, marketing channel, marketing interactions, and product. Within the attribution data warehouse 510, a process may match the marketing interactions 60 to specific customers using recorded unique, secondary, and tertiary identifiers.

The attribution rating engine 520 of the attribution system may utilize the collected marketing and customer data to attribute the value of the marketing interactions 60 to eventual customer acquisition. The attribution rating engine 520 may utilize a reinforcement learning model in which the result of marketing interactions 60 over discrete time steps may be utilized to identify effective marketing interactions 60 for selling a particular product or marketing program.

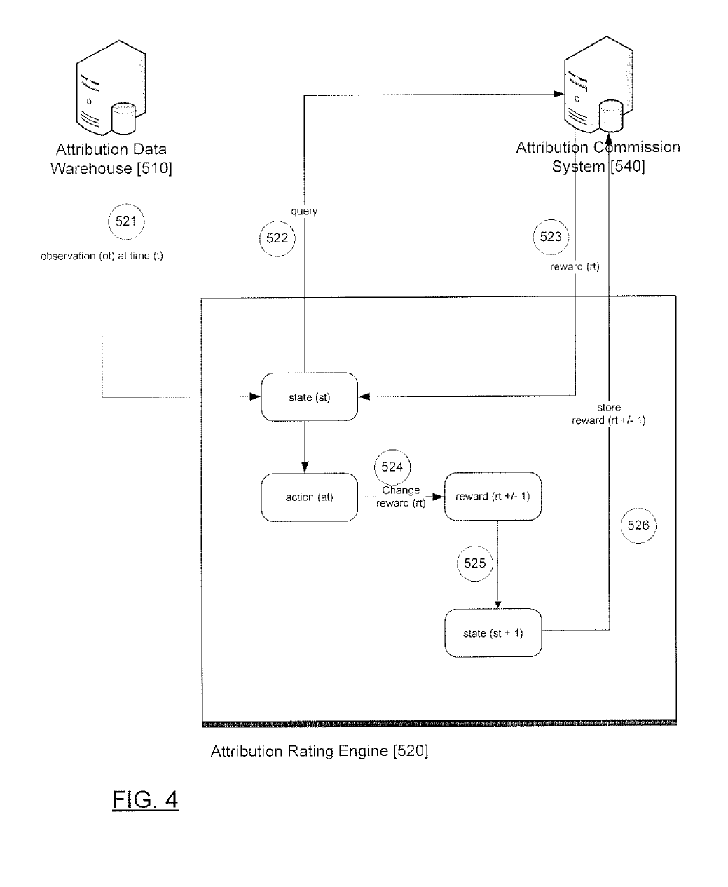

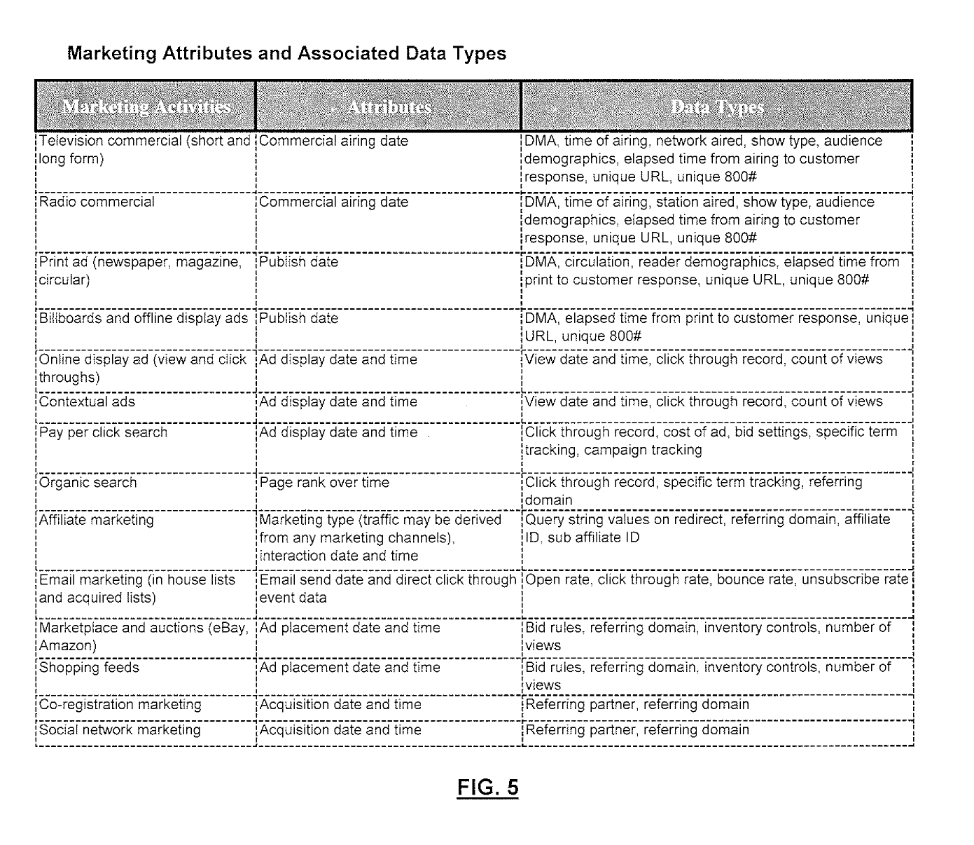

As shown in FIG. 4, in step 521, at each time (t), that a marketing interaction 60 or customer acquisition information related to the sale of goods and services or the placement of advertisement is recorded by the attribution data warehouse 510, the attribution data warehouse 510 may send an observation (ot) to the attribution rating engine 520. In step 522, when the attribution rating engine 520, in state (st), receives an observation (ot) from the attribution data warehouse 510, it may query the attribution commission system 540 for the corresponding reward. In step 523, the corresponding reward (rt) may be sent by the attribution commission system 540 to the attribution data warehouse 510. The marketer 40 may initially set the reward associated with each marketing interaction 60 and the customer acquisition attributes. This initial value may either be set manually using the marketing dashboard 70 or may be dynamically generated by the attribution rating engine 520 based on the historical information available to the attribution rating engine 520. The initial value of the reward may also be dynamically changed as the attribution rating engine's 520 learning model adjusts the reward. Alternatively, the attribution rating engine's 520 learning model may evaluate, but not change, the reward. Manual update to the reward may be made through the marketing dashboard 70 based upon the reports and feedback provided by the attribution rating engine 520.

In step 524, the attribution rating engine 520 may then choose an action (at) from the set of available actions including, but not limited to, increasing or reducing the reward (rt) by a predetermined or dynamically variable increment. The attribution rating engine 520 may also increment the counter for the marketing interaction 60 associated with the particular reward (rt). After modifying the reward associated with the observation (ot), the attribution rating engine 520 may move to a new state (st+1) in step 525. In step 526, the attribution rating engine 520 may store the new reward (rt+1) corresponding to the transaction at (st+1, at) in the attribution commission system 540. The attribution rating engine 520 may have visibility to the historical information regarding the different rewards associated with each individual observation (ot, t). The attribution rating engine 520 may choose any historical action (at+n) while updating the reward (rt) at a future time (t+n).

The attribution rating engine 520 may dynamically adjust the values of the reward associated with each marketing interaction 60 based upon events added to a queue. The most common event that may trigger a recalculation is new customer acquisition. Other events including, but not limited to, time between the marketing interaction 60 and customer acquisition, type of marketing interaction 60, specific vs. general association of marketing interaction 60 to customer acquisition, and the cost of marketing interaction 60 may be tracked by the attribution rating engine 520 and may also trigger a recalculation. At each new customer acquisition event, the attribution rating engine 520 may look at all marketing interactions 60 and customer acquisition attributes to determine if any one marketing interaction 60, customer acquisition attributes, or the combination of the two disproportionately influenced customer acquisition. If a specific marketing interaction 60 or attribute falls outside the normal distribution, the reward is proportionally adjusted.

In addition, other events may trigger the attribution rating engine 520 to perform pattern matches and other deeper analysis of the collected attributes and the marketing interactions 60 to adjust the rewards. This includes, but is not limited to the ability to look at defined and dynamic sets of marketing interactions 60 and customer acquisition attributes to determine if a specific combination of attributes and marketing interactions 60 results in a higher or lower probability of completing customer acquisition. This pattern recognition may be evaluated using decision trees, logistic regression, neural networks, or any exact match/fuzzy logic pattern matching algorithm. Once a pattern is recognized, that specific pattern becomes a mapping relationship between any combination of stored attributes and marketing interactions 60. This relationship may then be utilized by all components of the dynamic attribution system 50, including the output/reporting component 530.

The attribution rating engine 520 may provide real-time or near real-time reporting, which is rendered in a visibly perceptible output, on the performance of the different marketing interactions 60 to the marketer 40 through physical reports or in electronic format using the output/reporting component 530. For each customer acquisition, the attribution rating engine 520 may determine and report on a detailed attribution path time-lining each marketing interaction 60 that contributed to the customer acquisition, the ranking of all the marketing interactions 60 that led to the customer acquisition, and the commission or payment payouts made for customer acquisition. The attribution rating engine 520 may also track and report on the time between marketing interaction 60 and customer acquisition; the correlation, if any, between the customer acquisition attributes and marketing interaction 60; specific vs. general association of marketing interaction 60 to customer acquisition; and the cost of marketing interaction 60. The marketer 40 may use this visible perceptible output provided by the attribution rating engine 520 through the output/reporting component 530 to optimize the resources devoted to different marketing interactions 60 and prioritize the more effective marketing interactions 60 through the marketing dashboard 70. in addition, this information may be provided to the approved marketing partners 30 to enable them to refine their marketing activities.

The attribution commission system 540 may also compute commission payout rates for the approved marketing partners 30 based on their contribution to the marketing interactions 60 that resulted in a specific customer acquisition. The calculation of the payout rate may be influenced by whether the approved marketing partner 30 is an Introducer, Influencer, or Closer during the particular customer acquisition process. The status of whether the approved marketing partner 30 is an Introducer, Influencer, or Closer during the particular customer acquisition process may be tracked by the attribution rating engine 520, which may store the status in the attribution data warehouse 510. The Introducer is be the first approved marketing partner 30 that generates a marketing interaction 60, which leads to customer acquisition. The Closer is be the last approved marketing partner 30 that generates a marketing interaction 60, which leads to customer acquisition. The Influencer may be any approved marketing partner 30 that generates a marketing interaction 60 during the customer acquisition process.

Using the marketing dashboard 70, the total commission for each customer acquisition may be initially defined by the marketers 40 in the attribution commission system 540. The payout rates for the Introducer, Influencer, and Closer may be defined at the start of a marketing campaign for a specific customer acquisition. Alternatively, the payout rates for the Introducer, Influencer, and Closer may be automatically computed and rendered in a visibly perceptible output by the attribution rating engine 520 based upon historical customer acquisition commission rates for similar marketing campaigns that are stored in the attribution commission system 540. The marketers 40 may also define a look-back window, i.e., the period in which the marketing interaction 60 can contribute to customer acquisition. Typical look-back window time periods may be thirty (30) days. Alternatively, the look-back window may be defined in the attribution commission system 540 by a combination of marketing interaction 60 and customer acquisition attributes and rendered in a visibly perceptible output.

A reward value may be assigned to each combination of a marketing interaction 60 and a specific customer acquisition. This value may be initially defined manually, or may be automatically determined by using historic data from a similar marketing interaction 60 and customer acquisition. A reward value of 1 may be defined if that specific marketing interaction 60 is no more and no less likely to contribute to a customer acquisition than the average of all marketing interaction 60. The initial value of the reward may be dynamically changed as the attribution rating engine's 520 learning model adjusts the reward. Alternatively, the attribution rating engine's 520 learning model may evaluate, but not change, the reward. Manual update to the reward may be made through the marketing dashboard 70 based upon the reports and feedback provided by the attribution rating engine 520. The commission payout system may utilize the adjusted reward value for each marketing interaction 60, the status of the approved marketing partner 30, the customer acquisition attributes, and the look-back period to compute the payout rate for the Introducer, Influencer, and Closer when a specific customer acquisition is completed.

As will be understood by those skilled in the art, the invention may be embodied in other specific forms without departing from the spirit or essential characteristics thereof. For example, the particular architecture depicted above are merely exemplary of one implementation of the present invention. The functional elements and method steps described above are provided as illustrative examples of one technique for implementing the invention; one skilled in the art will recognize that many other implementations are possible without departing from the present invention as recited in the claims. In addition, the present invention may be implemented as a method, process, user interface, computer program product, system, apparatus, or any combination thereof. Accordingly, the disclosure of the present invention is intended to be illustrative, but not limiting, of the scope of the invention. It is intended that the present invention cover all such modifications and variations of the invention, provided they come within the scope of the appended claims and their equivalents.

What is claimed is:

1. A computer implemented method of determining commission payout for marketing partners based on their contribution to a marketing interactions that resulted in customer acquisition, comprising the steps of:
defining the initial commission payout rate for each marketing interactions;
determining whether the marketing interactions was carried out by an introducer, influencer, or closer;
reevaluating the initial commission for each marketing interactions that was carried out during customer acquisition;
changing the reward information in response to the reevaluation to arrive at a revised commission payout rate;
calculating the commission payout for marketing partners based on the revised commission payout rate and their status as introducer, influencer, or closer; and
providing a computer implemented display indicative of the determined commission payout for the marketing partners.

2. The method of claim 1, wherein the computer implemented display indicative of the determined commission payout is provided to the marketing partners only if the marketing interaction occurred within a look-back window.

3. The method of claim 1 wherein the initial commission is automatically computed based upon historical customer acquisition commission rates for similar marketing campaigns.
